(19) United States
(12) Patent Application Publication
(10) Pub. No.: US 2018/0119785 A1
(43) Pub. Date: May 3, 2018

(54) Power Converter Having A Ball-Type Continuously Variable Transmission

(71) Applicant: Dana Limited, Maumee, OH (US)

(72) Inventor: Kenneth E. Cooper, Las Vegas, NV (US)

(21) Appl. No.: 15/857,785

(22) Filed: Dec. 29, 2017

Related U.S. Application Data
(60) Provisional application No. 62/587,539, filed on Nov. 17, 2017.

(51) Int. Cl. F16H 37/08; F16H 59/40; F16H 15/50; F16H 61/664; F16H 59/70; F16H 63/06

(52) U.S. Cl. CPC F16H 37/084; F16H 59/40; F16H 15/50; F16H 2061/6641; F16H 59/70; F16H 63/067; F16H 2037/0866; F16H 61/6645

(57) ABSTRACT

Devices and methods are provided herein for the transmission of power in motor vehicles. Power is transmitted in a smoother and more efficient manner by splitting torque into two or more torque paths. In some embodiments, a power converter is configured to have a ball-type variator and two planetary gear sets. Two clutches selectively engagement members of the variator to provide an infinitely variable transmission mode and a continuously variable transmission mode.

### RELATED APPLICATION

This application claims the benefit of U.S. Provisional Patent Application No. 62/587,538, filed Nov. 17, 2017, which is incorporated herein by reference in its entirety.

### BACKGROUND

A power converter including a continuously variable transmission allows an operator or a control system to vary a drive ratio in a stepless manner, permitting a power source to operate at its most advantageous rotational speed.

### SUMMARY

Provided herein is a power converter including: an input shaft; an output shaft; a variator having a first plurality of balls, each ball provided with a tiltable axis of rotation, each ball in contact with a first traction ring assembly and a second traction ring assembly, and each ball operably coupled to a first carrier assembly, wherein the second traction ring operably coupled to the output shaft; a first planetary gear set having a first ring gear, a first planet carrier supporting a first plurality of planet gears coupled to the first ring gear, the first planet carrier operably coupled to the input shaft, and a first sun gear coupled to the first plurality of the planet gears, the first sun gear operably coupled to the output shaft; a second planetary gear set having a second ring gear operably coupled to the first traction ring assembly, a second planet carrier supporting a second plurality of planet gears coupled to the second ring gear, the second planet carrier operably coupled to the first ring gear, and a second sun gear coupled to the second plurality of the planet gears, the second sun gear operably coupled to the carrier assembly; a first clutch coupled to the carrier assembly and the second sun gear, wherein the first clutch is configured to selectively couple to ground; and a second clutch coupled to the first traction ring assembly and the second ring gear, wherein the second clutch is configured to selectively couple to ground.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the preferred embodiments will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic of a power converter having a ball-type variator and two planetary gear sets.

FIG. 5 is a table depicting operating modes of the power converter of FIG. 4.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention include several novel features, no single one of which is solely responsible for its desirable attributes or which is essential to practicing the inventions described.

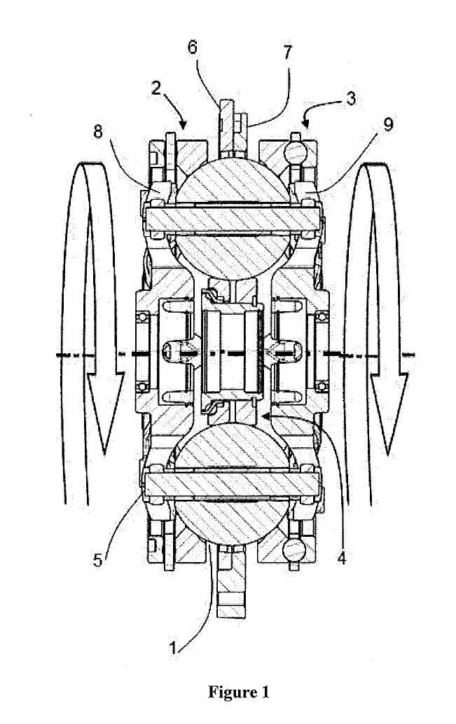

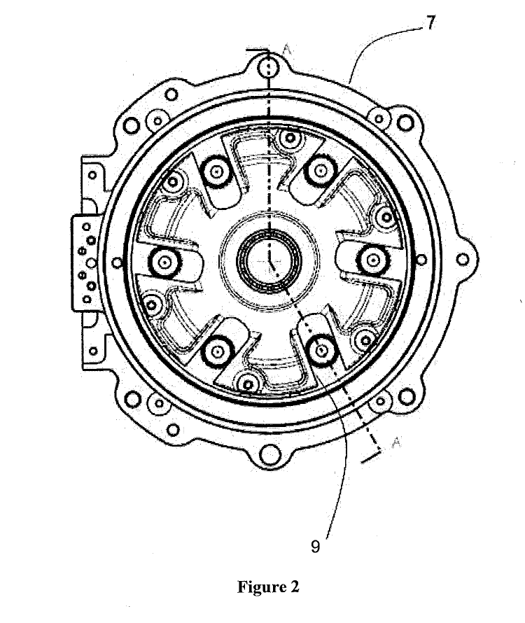

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, an input (first) 2 and output (second) 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 9 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

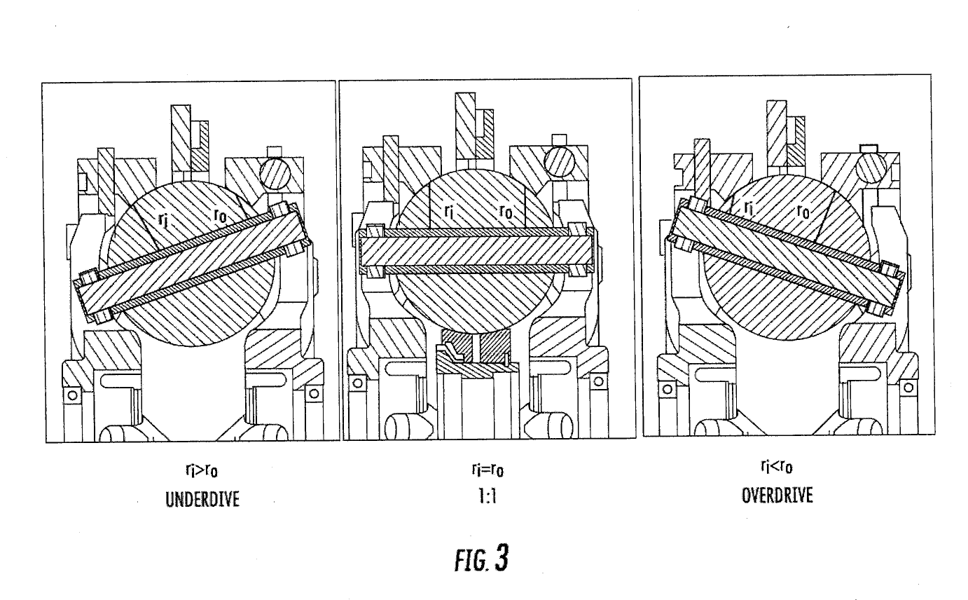

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The preferred embodiments disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

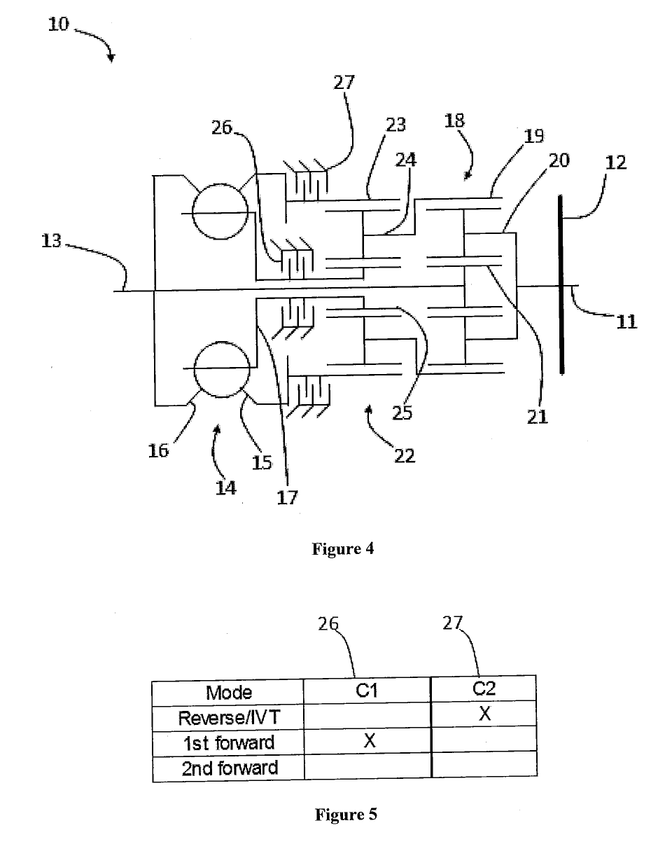

Referring now to FIG. 4, in some embodiments, a power converter 10 includes an input shaft 11 operably coupled to a source of rotational power through, for example, an engine damper 12. The power converter 10 includes an output shaft 13 adapted to transfer rotational power out of the power converter 10. The power converter 10 includes a variator 14 that is similar to the variator depicted in FIGS. 1-3. The variator 14 includes a first traction ring assembly 15, a second traction ring assembly 16, and a carrier assembly 17. The second traction ring assembly 16 is coupled to the output shaft 13. In some embodiments, the power converter 10 includes a first planetary gear set 18 having a first ring gear 19, a first planet carrier 20, and a first sun gear 21. In some embodiments, the first planet carrier 20 is operably coupled to the input shaft 11. The first sun gear 21 is coupled to the output shaft 13. The power converter 10 includes a second planetary gear set 22 having a second ring gear 23, a second planet carrier 24, and a second sun gear 25. In some embodiments, the second planet carrier 24 is coupled to the first ring gear 19. The power converter 10 includes a first clutch 26 and a second clutch 27. The first clutch 26 is coupled to the carrier assembly 17 and the second sun gear 25. The first clutch 26 is configured to selectively couple to a grounded member of the power converter 10, such as a housing (not shown). The second clutch 27 is coupled to the first traction ring assembly 15 and to the second ring gear 23. The second clutch 27 is configured to selectively couple to a grounded member of the power converter 10, such as a housing (not shown).

Referring to FIG. 5, during operation of the power converter 10, a number of operating modes are achieved by engagement and disengagement of the first clutch 26 and the second 27. An infinitely variable transmission (IVT) mode of operation corresponds to disengagement of the first clutch 26 and engagement of the second clutch 27. The IVT mode of operation provides forward and reverse direction of the output shaft 13. A first forward mode of operation corresponds to engagement of the first clutch 26 and disengagement of the second clutch 27. A second forward mode of operation corresponds to disengagement of the first clutch 26 and the second clutch 27.

While preferred embodiments of the present invention have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein are capable of being employed in practicing the invention. It is intended that the following claims define the scope of the invention and that methods and structures within the scope of these claims and their equivalents be covered thereby.

What is claimed is:

1. A power converter comprising:
an input shaft;
an output shaft;
a variator having a first plurality of balls, each ball provided with a tiltable axis of rotation, each ball in contact with a first traction ring assembly and a second traction ring assembly, and each ball operably coupled to a first carrier assembly, wherein the second traction ring operably coupled to the output shaft;
a first planetary gear set having a first ring gear, a first planet carrier supporting a first plurality of planet gears coupled to the first ring gear, the first planet carrier operably coupled to the input shaft, and a first sun gear coupled to the first plurality of the planet gears, the first sun gear operably coupled to the output shaft;
a second planetary gear set having a second ring gear operably coupled to the first traction ring assembly, a second planet carrier supporting a second plurality of planet gears coupled to the second ring gear, the second planet carrier operably coupled to the first ring gear, and a second sun gear coupled to the second plurality of the planet gears, the second sun gear operably coupled to the carrier assembly;
a first clutch coupled to the carrier assembly and the second sun gear, wherein the first clutch is configured to selectively couple to ground; and
a second clutch coupled to the first traction ring assembly and the second ring gear, wherein the second clutch is configured to selectively couple to ground.

2. The powertrain of claim 1, further comprising an engine damper coupled to the input shaft.

3. The powertrain of claim 1, wherein engagement of the second clutch and disengagement of the first clutch corresponds to an infinitely variable operating mode.

4. The powertrain of claim 1, wherein engagement of the first clutch and disengagement of the second clutch corresponds to a continuously variable operating mode in the forward direction.
